(19) United States
(12) Patent Application Publication
(10) Pub. No.: US 2024/0389170 A1
(43) Pub. Date: Nov. 21, 2024

(54) METHODS AND NETWORK NODES FOR VERIFYING CELL RELATIONS IN A WIRELESS COMMUNICATION NETWORK

(71) Applicant: Telefonaktiebolaget LM Ericsson (publ), Stockholm (SE)

(72) Inventors: Daniel Henriksson, Linköping (SE); Tobias Ahlström, Ljungsbro (SE)

(21) Appl. No.: 18/686,090

(22) PCT Filed: Sep. 1, 2021
(86) PCT No.: PCT/SE2021/050848

§ 371 Date: Feb. 23, 2024

(51) Int. Cl. H04W 76/11

(52) U.S. Cl. CPC H04W 76/11

(57) ABSTRACT

Disclosed is a method performed by a first network node of a wireless communication network, the first network node being of a first radio access network technology. The wireless communication network further comprises a second network node of a second radio access technology. The first network node has a direct signaling connection to a core network whereas the second network node is signaling-connected to the core network via the first network node. The method comprises receiving, from a UE that has a primary connection to the first network node, a Physical Cell Identity, PCI, that matches a PCI of a cell controlled by the second network node, and in response to the reception of the PCI, sending a request to the second network node initiating the second network node to set-up a secondary connection with the UE.

### TECHNICAL FIELD

The present disclosure relates generally to methods and network nodes for verifying cell relations in a wireless communication network. More specifically, the disclosure relates to verifying cell relations in a wireless communication network comprising a first network node of a first radio access network technology, and a second network node of a second radio access technology, where the first network node has a direct signaling connection to a core network whereas the second network node is signaling-connected to the core network via the first network node. The present disclosure further relates to computer programs and carriers corresponding to the above methods and nodes.

### BACKGROUND

The main task of a wireless communication network is to provide good radio connections for wireless communication devices, aka wireless devices aka User Equipments (UEs) to carry communication services the users of the UEs want to utilize. In this process it is central to find the most suitable cells or antenna beams (in the following only referred to as cells) for every UE as it moves around. This is today performed by requesting the UE to measure strength and quality of radio signals sent from radio access network (RAN) nodes handling the cells, both of serving cells and of neighbor cells. The serving cell is the cell in which the UE resides/is connected to. The neighbor cells are cells that are neighbors to the serving cell and which the UE may transit into as it moves around. The results of the measurements of strength and quality of serving cells and neighbor cells are reported by the UE to the RAN, which decides what cell(s) shall serve the UE in the following. These measurements of strength and quality that are reported to the RAN are normally accompanied with the physical cell identity (PCI) of the cell in order for the RAN to identify which measurement belongs to which cell.

In order to limit the amount of communication resources needed for sending the ID of the cell together with the measurements, the PCI comprises a bit sequence of less number, as compared to a global cell identity (CGI), which is a unique ID for each cell and therefore very long. As result of the PCI length being shorter, the UEs can more easily acquire it, but it also means that there is a smaller number of PCIs available in the network. Thus, the PCIs need to be reused in different cells throughout the network. This means that a PCI conflict situation may occur. A PCI conflict occurs when the PCIs are reused too tightly in the network so that two cells that are neighbors or neighbors' neighbors use the same PCI. The PCI conflict situation can be divided into two different situations, PCI confusion and PCI collision. A PCI confusion occurs when a first cell has two neighbor cells where both those neighbor cells have the same PCI and frequency. Then it will be confusing for the first cell, which of the two cells that the different measurements sent from the UE refer to. A PCI collision occurs when the first cell has a neighbor that has the same PCI as the first cell. When there is a PCI collision, it is not possible for the UE to detect that it gets out of coverage of the first cell and into the second cell with the same PCI as the first cell. The result will most probably be a lost call.

A good PCI allocation without PCI conflicts is important since it will provide the following benefits, among other: better mobility features performance; increased throughput in the network; better carrier aggregation performance, increased retainability, and reduced interference. Further, a good PCI allocation provides improved utilization in Non-Stand Alone (NSA) systems among others.

NSA systems are systems where a first network node of a first radio access technology has a direct signaling connection with a core network, but a second network node of a second radio access technology only has a signaling connection with the core network node via the first network node. Here the term signaling connection is equivalent to control plane connection. The purpose with such NSA systems is to provide Dual Connectivity to UEs. Dual Connectivity (DC) means that a UE has two connections with the wireless communication network, a primary connection with the first network node that has the direct signaling connection with the core network but in addition to the primary connection also a secondary connection with the second network node that is connected to the core network via the first network node. In DC, the first network node providing the primary connection is called a primary node whereas the second network node providing the secondary connection is called a secondary node. Dual connectivity allows a UE to aggregate signals from two different network nodes of two different radio access technologies to achieve a higher throughput and a more robust connection with the network.

An example of an NSA system is a wireless communication network having a network node of a Long Term Evolution (LTE) radio access technology, called eNodeB, the eNodeB having a direct signaling connection with the core network, and a network node of a New Radio (NR) radio access technology, called gNodeB, the gNodeB being signaling-connected with the core network via the eNodeB. Another example of an NSA system is the other way around, that is a wireless communication network having a gNodeB with a direct signaling connection with the core network, and a an eNodeB that is signaling-connected with the core network via the gNodeB.

In such an NSA system, the first network node, which is the primary node that has the primary connection with the UE, can determine that the UE needs a secondary connection, based on certain aspects such as a need for higher throughput. As mentioned, the UE measures signal strength on signals sent by neighboring network nodes of the second radio access technology together with the Physical Cell Identity (PCI) of the cell into which the signals are sent. The UE then sends those measurements together with their respective PCIs to the primary node. The primary node determines, based on those measurements and on the PCIs that accompany the measurements, that a secondary connection is to be set-up for the UE towards the second network node. The primary node then sends a secondary node addition request to the second network node, and the second network node tries to set up a secondary connection with the UE. However, if there are two cells of the second radio access technology that has the same PCI, a PCI conflict may occur. In other words, there is a risk that the secondary node addition request is sent to the wrong network node, that is a network node that does not serve the cell where the UE is.

A similar situation may occur when the UE already has both a primary connection to a network node of the first radio access technology and a secondary connection to a network node of the second radio access technology and change of secondary cell is initiated. The initiation of change of secondary cell may be based on the UE moving from an original serving cell of a third network node of the second radio access technology towards a cell of the second network node. In case there is a PCI conflict in the network part of the second radio access technology, the primary node may then send a secondary node change request message to the wrong network node of the second radio access technology.

The result in both situations above is then that a secondary connection cannot be set up for the UE at the second network node. Consequently, there is a need to solve such situations, or at least to improve the handling of such situations so that a secondary connection can be set up quicker than today.

### SUMMARY

It is an object of the invention to address at least some of the problems and issues outlined above. It is possible to achieve these objects and others by using methods and network nodes as defined in the attached independent claims.

According to one aspect, a method is provided that is performed by a first network node of a wireless communication network. The first network node is of a first radio access network technology. The wireless communication network further comprises a second network node of a second radio access technology. The first network node has a direct signaling connection to the core network whereas the second network node is signaling-connected to the core network via the first network node. The method comprises receiving, from a UE that has a primary connection to the first network node, a PCI that matches a PCI of the cell controlled by the second network node, and in response to the reception of the PCI, sending a request to the second network node initiating the second network node to set-up a secondary connection with the UE. The method further comprises receiving, from the second network node, an acknowledgement of a performed secondary connection set-up with the UE, the acknowledgement comprising an ID of the UE, or, obtaining information on a secondary connection set-up failure with the UE.

By receiving, from the second network node, an acknowledgement of a performed secondary connection set-up with the UE, or, obtaining information on a secondary connection set-up failure with the UE, the first network node will actively be informed whether the secondary connection set-up was successful or not. Thereby, the first network node will know whether it needs to take any action to e.g. secure connection set-up for the UE in case the secondary connection set-up was not successful. In prior art methods, the first network node is not informed whether the secondary connection set-up is successful or not and will therefore not know whether it needs to take any such action.

According to another aspect, a method is provided performed by a first network node of a wireless communication network, the first network node being of a first radio access network technology. The wireless communication network further comprising a second network node and a third network node, both of a second radio access technology. The first network node has a direct signaling connection to the core network whereas the second and third network nodes are signaling-connected to the core network via the first network node. The method comprises receiving, from the third network node, for a UE that has a primary connection to the first network node and a secondary connection to the third network node, a request of a change of secondary connection, initiated by the UE entering a cell with a PCI matching a PCI of a cell controlled by the second network node, the request comprising an ID of the second network node, and in response to the receiving, sending a request to the second network node initiating the second network node to set-up a secondary connection with the UE, the request comprising the ID of the UE. The method further comprises receiving, from the second network node, an acknowledgement of a performed secondary connection set-up with the UE, the acknowledgement comprising an ID of the UE, or, obtaining information on a secondary connection set-up failure with the UE.

According to another aspect, a method is provided performed by a second network node of the wireless communication network, the second network node being of a second radio access network technology. The wireless communication network further comprises a first network node of a first radio access technology. The first network node has a direct signaling connection to the core network whereas the second network node is signaling-connected to the core network 120 via the first network node. The method comprises receiving a request from the first network node to set-up a secondary connection with a UE, the request including the ID of the UE, and after the receiving of the request, attempting to set up a secondary connection with the UE. The method further comprises determining whether the attempt of secondary connection set-up was successful, and sending, to the first network node and in response to the determining that the secondary connection set-up was successful, an acknowledgement of a performed secondary connection set-up with the UE, the acknowledgement comprising an ID of the UE.

According to another aspect, a method is provided performed by a third network node of the wireless communication network, the third network node being of a second radio access network technology. The wireless communication network further comprises a first network node of a first radio access technology and a second network node of the second radio access technology. The first network node has a direct signaling connection to a core network whereas the second network node and the third network node are signaling-connected to the core network via the first network node. The method comprises sending, to the first network node, for a UE that has a primary connection to the first network node and a secondary connection to the third network node, a request of a change of secondary connection, initiated by the UE entering a cell with a PCI matching a PCI of a cell controlled by the second network node, the request comprising an ID of the second network node. The method further comprises receiving, from the first network node information on an acknowledgement of a secondary connection set-up with the UE, or receiving information on a secondary connection set-up failure, depending on whether the secondary connection set-up was successful or not, the information comprising an ID of the UE, the secondary connection set-up being initiated by the second network node at request by the first network node in response to the sent request of change of secondary connection.

According to yet another aspect, a first network node is provided that is configured to operate in a wireless communication network. The first network node is of a first radio access network technology. The wireless communication network further comprising a second network node of a second radio access technology. The first network node is configured to have a direct signaling connection to a core network whereas the second network node is configured to be signaling-connected to the core network via the first network node. The first network node comprises a processing circuitry and a memory. Said memory contains instructions executable by said processing circuitry, whereby the first network node is operative for receiving, from a UE that has a primary connection to the first network node, a PCI that matches a PCI of a cell controlled by the second network node, and in response to the reception of the PCI, sending a request to the second network node initiating the second network node to set-up a secondary connection with the UE. The first network node is further operative for receiving from the second network node, an acknowledgement of a performed secondary connection set-up with the UE, the acknowledgement comprising an ID of the UE, or, obtaining information on a secondary connection set-up failure with the UE.

According to another aspect, a first network node is provided that is configured to operate in a wireless communication network, the first network node being of a first radio access network technology. The wireless communication network further comprises a second network node as well as a third network node both of a second radio access technology. The first network node is configured to have a direct signaling connection to the core network whereas the second network node and the third network node are configured to be signaling-connected to the core network via the first network node. The first network node comprises a processing circuitry and a memory. Said memory contains instructions executable by said processing circuitry, whereby the first network node is operative for receiving, from the third network node, for a UE that has a primary connection to the first network node and a secondary connection to the third network node, a request of a change of secondary connection, initiated by the UE entering a cell with a PCI matching a PCI of a cell controlled by the second network node, the request comprising an ID of the second network node, and, in response to the receiving, sending a request to the second network node initiating the second network node to set-up a secondary connection with the UE, the request comprising the ID of the UE. Further, the first network node is operative for receiving, from the second network node, an acknowledgement of a performed secondary connection set-up with the UE, the acknowledgement comprising an ID of the UE, or, obtaining information on a secondary connection set-up failure with the UE.

According to another aspect, a second network node is provided that is configured to operate in a wireless communication network. The second network node is of a second radio access network technology. The wireless communication network further comprising a first network node of a first radio access technology. The first network node is configured to have a direct signaling connection to a core network whereas the second network node is configured to be signaling-connected to the core network via the first network node. The second network node comprises a processing circuitry and a memory. Said memory contains instructions executable by said processing circuitry, whereby the second network node is operative for receiving a request from the first network node to set-up a secondary connection with a UE, the request including the ID of the UE, and, after the receiving of the request, attempting to set up a secondary connection with the UE. The second network node is further operative for determining whether the attempt of secondary connection set-up was successful, and sending, to the first network node and in response to the determining that the secondary connection set-up was successful, an acknowledgement of a performed secondary connection set-up with the UE, the acknowledgement comprising an ID of the UE.

According to another aspect, a third network node is provided that is configured to operate in a wireless communication network, the third network node being of a second radio access network technology. The wireless communication network further comprising a first network node of a first radio access technology and a second network node of the second radio access technology. The first network node is configured to have a direct signaling connection to a core network whereas the second network node and the third network node are configured to be signaling-connected to the core network via the first network node. The third network node comprises a processing circuitry and a memory. Said memory contains instructions executable by said processing circuitry, whereby the third network node is operative for sending, to the first network node, for a UE that has a primary connection to the first network node and a secondary connection to the third network node, a request of a change of secondary connection, initiated by the UE 140 entering a cell with a PCI matching a PCI of a cell controlled by the second network node, the request comprising an ID of the second network node. The third network node is further operative for receiving, from the first network node information on an acknowledgement of a secondary connection set-up with the UE, or receiving information on a secondary connection set-up failure, depending on whether the secondary connection set-up was successful or not, the information comprising an ID of the UE, the secondary connection set-up being initiated by the second network node at request by the first network node in response to the sent request of change of secondary connection.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic view of a wireless communication network in which the present invention may be used.

FIG. 2 is a flow chart illustrating a procedure of a first network node for set-up of a secondary connection for a UE at a second node, according to possible embodiments.

FIG. 3 is a flow chart illustrating a procedure of a first network node for changing secondary connection for a UE from a third node to a second node, according to possible embodiments.

FIG. 4 is a flow chart illustrating a procedure of a second network node for set-up and change of a secondary connection for a UE, according to possible embodiments.

FIG. 5 is a flow chart illustrating a procedure of a third network node for changing secondary connection for a UE from the third node to a second node according to possible embodiments.

FIG. 6 is a signaling diagram illustrating an example of a procedure for set-up of a secondary connection for a UE, according to further possible embodiments.

FIG. 7 is a signaling diagram illustrating an example of a procedure for changing secondary connection for a UE, according to further possible embodiments.

FIG. 8 is a block diagram illustrating a first network node in more detail, according to further possible embodiments.

FIG. 9 is a block diagram illustrating a second network node in more detail, according to further possible embodiments.

FIG. 10 is a block diagram illustrating a third network node in more detail, according to further possible embodiments.

### DETAILED DESCRIPTION

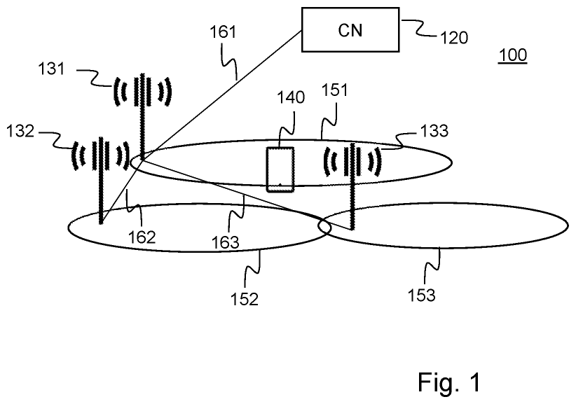

FIG. 1 shows a wireless communication network 100 comprising a first radio access network (RAN) node aka network node 131 of a first radio access technology, as well as a second network node 132 and a third network node both of a second radio access technology. The first, second and third network node 131, 132, 133 are adapted for wireless communication with a wireless communication device aka wireless device 140. The first network node 131 provides radio access in a cell 151, the second network node 132 provides radio access in a cell 152 and the third network node 133 provides radio access in a cell 153. The wireless communication network 100 further comprises a core network 120. The first network node 131 has a direct signaling connection 161 to the core network 120. The second network node 132 has a signaling connection 162 to the first network node 131, and the first network node 131 provides the signaling connection of the second network node 132 to the core network 120 via its direct signaling connection 161. The third network node 133 also has a signaling connection 163 to the first network node 131, and the first network node 131 provides the signaling connection of the third network node 133 to the core network 120 via its direct signaling connection 161.

The wireless communication network 100 is an NSA system as described in the Background. The first and second radio access technologies may be any of the following technologies: Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network. A typical NSA system in which the present invention may be used is where the first network node 131 is an eNodeB, i.e. an LTE network node, and the second and third network node 132, 133 are gNodeBs, i.e. NR network nodes. In this system, the core network 120 would be an Evolved Packet Core (EPC), i.e. a fourth Generation (4G) core network, adapted for communication with LTE network nodes, i.e. eNodeBs (eNB). Such a system is described in more detail in 3GPP TS 37.340, version 16.6, where the first network node is equivalent with the unit called “eNB” and the second/third network node is equivalent with the unit called “En-gNB”. Another typical NSA system in which the present invention may be used is where the first network node 131 is a gNodeB and the second and third network nodes 132, 133 are eNodeBs. In this system, the core network 120 would be a 5G Core network (5GC), adapted for communication with 5G network nodes, i.e. gNodeBs (gNB). Such a system is described in more detail in the above mentioned 3GPP TS 37.340 version 16.6, where the first network node is equivalent with the unit called “gNB” and the second/third network node is equivalent with the unit called “NE-eNB”.

The network nodes 131, 132, 133 may be any kind of network node that can provide wireless access to a wireless device 140 alone or in combination with another network node. Examples of network nodes 131, 132, 133 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a remote radio unit (RRU), a remote radio head (RRH) and a multi-standard BS (MSR BS).

The wireless device 140 may be any type of device capable of wirelessly communicating with the network nodes 131, 132, 133 using radio signals. For example, the wireless device 140 may be a User Equipment (UE), a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE) etc.

When investigating the problem of PCI conflicts in NSA systems, such as the one shown in FIG. 1, the inventors have observed that in today's system, there is no feedback sent to the first network node 131, i.e. the primary node for this UE 140, to inform the primary node 131 whether the set-up of a secondary connection at the second network node 132 to the UE over the radio interface was successful or not. In other words, the primary node 131 cannot act on any lost or not set up secondary connection. Also, as the primary node is not informed of any lost secondary connection, it may happen after a not-successful set-up or change of secondary connection to a certain network node that the next time the UE needs to change or set-up secondary connection with the same network node, the same loss of secondary connection occurs again. According to the invention, the inventors have therefore suggested that the second network node 132 sends to the first network node 131, an acknowledgement of a performed secondary connection set-up with the UE, or the first network node 131 obtains information on a secondary connection set-up failure with the UE, for example by the second network node 132 sending such information. The first network node 131 can then directly take actions on such information such as collecting statistics to improve handling of later secondary connection set-ups or requesting a GCI.

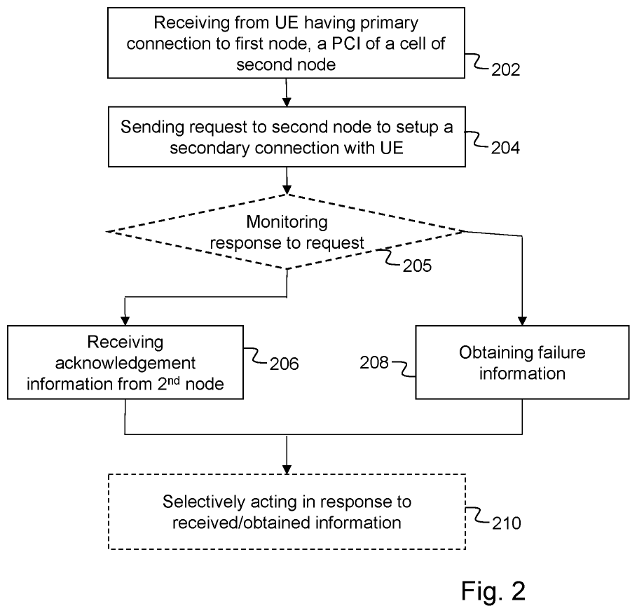

FIG. 2, in conjunction with FIG. 1, shows a method of the present invention, the method being performed by the first network node 131 of the wireless communication network 100. The first network node 131 is of a first radio access network technology. The wireless communication network 100 further comprises a second network node 132 of a second radio access technology. The first network node 131 has a direct signaling connection to the core network 120 whereas the second network node 132 is signaling-connected to the core network 120 via the first network node 131. The method comprises receiving 202, from a UE 140 that has a primary connection to the first network node 131, a PCI that matches a PCI of the cell 152 controlled by the second network node 132, and in response to the reception of the PCI, sending 204 a request to the second network node 132 initiating the second network node to set-up a secondary connection with the UE 140. The method further comprises receiving 206, from the second network node 132, an acknowledgement of a performed secondary connection set-up with the UE 140, the acknowledgement comprising an ID of the UE 140, or, obtaining 208 information on a secondary connection set-up failure with the UE 140.

The PCI may be received 202 in connection with a request for secondary connection set-up from the UE. The PCI may be received 202 together with measurements of strength and/or quality of signals sent by the second network node 132 and received by the UE 140, which measurements the first network node 131 uses to determine to set up a secondary connection for the UE with the second network node 132. The acknowledgement is received 206 from the second network node in response to the second network node determining that an attempt of secondary connection set-up with the UE was successful. The information on secondary connection set-up failure is obtained 208 as a result of a failing attempt to set-up a secondary connection initiated by the second network node. The information on secondary connection set-up failure may be obtained 208 as information received from the second network node 132, the information comprising the ID of the UE 140. Alternatively, the information may be obtained by the first network node 131 determining that there is a secondary connection set-up failure when no acknowledgement of performed secondary connection set-up has been received from the second network node 132 within a defined time period from the sending 204 of the request to the second network node 132.

That the first network node 131 is of a first radio access network technology and the second network node 132 is of a second radio access network technology means that they communicate according to a first and a second radio access network technology, respectively. The first and the second radio access network technologies may be different radio access network technologies. In an alternative embodiment, the first and the second radio access network technologies may be the same type of radio access technology. The first network node may also be called a master network node or a primary network node. The second network node may be called a secondary network node as opposed to the primary network node. The first radio access network technology may be LTE and the second radio access network technology NR, or vice versa. However, other technologies may apply to the first and second radio access network technology. In the alternative embodiment, the first and the second radio access technology may be NR, so called NR-NR DC. A signaling connection is equivalent to a control plane connection. That the second network node 132 is signaling-connected to the core network 120 via the first network node 131 implies that the second network node 132 does not have any direct signaling connection to the core network node 120, i.e. no direct control plane connection to the core network 120, but needs to signal via the first network node 131 to get in contact with the core network 120. However, the second network node 132 may have a direct user plane connection to the core network 120, i.e. user data can be sent directly between the core network 120 and the second network node 132 but control signaling between the second network node 132 and the core network 120 has to be sent via the first network node 131. The request to the second network node 132 initiating the second network node 132 to set-up a secondary connection with the UE 140 may be called a Secondary node addition request. The first network node 131 has information of which network node that handles which cells, i.e. a connection between PCI and network node ID, so from the received PCI information and its stored connection information the first network node 131 finds the ID of the second network node 132.

By the first network node 131 getting to know whether the secondary connection set-up was successful or not, it will know whether it needs to take any action to e.g. secure an alternative connection set-up in the second radio access technology for the UE 140 in case the secondary connection set-up was not successful. In prior art methods, the first network node 131 will not know whether the secondary connection set-up was successful or not and will therefore not know whether it needs to take any such action. The action that the first network node 131 may take can be to request a Cell Global Identity (CGI) of the cell, in case the reason for the non-successful connection set-up was a PCI conflict. Another action that the first network node 131 may take can be to collect information on received acknowledgements, and information on secondary connection set-up failures over time, and based on such collected statistics on received acknowledgements and failures take actions such as determining whether to perform a PCI reallocation or whether to perform a PCI re-planning for the wireless communication network 100 or part of the network.

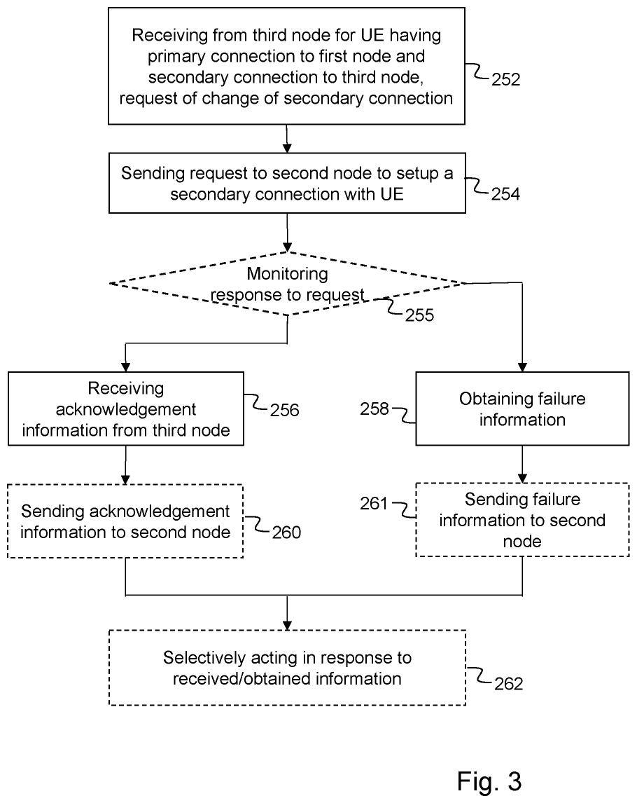

FIG. 3, in conjunction with FIG. 1, shows another method of the present invention, the method being performed by the first network node 131 of the wireless communication network 100 and the first network node 131 being of a first radio access network technology. The wireless communication network 100 further comprising a second network node 132 and a third network node 133, both of a second radio access technology. The first network node 131 has a direct signaling connection to the core network 120 whereas the second and third network nodes 132, 133 are signaling-connected to the core network 120 via the first network node 131. The method comprises: receiving 252, from the third network node 133, for a UE 140 that has a primary connection to the first network node 131 and a secondary connection to the third network node 133, a request of a change of secondary connection, initiated by the UE 140 entering a cell with a PCI matching a PCI of a cell controlled by the second network node 132, the request comprising an ID of the second network node, and in response to the receiving 252, sending 254 a request to the second network node 132 initiating the second network node 132 to set-up a secondary connection with the UE 140, the request comprising the ID of the UE 140. The method further comprises receiving 256, from the second network node 132, an acknowledgement of a performed secondary connection set-up with the UE 140, the acknowledgement comprising an ID of the UE 140, or, obtaining 258 information on a secondary connection set-up failure with the UE.

This method is for the case where the secondary connection is to be moved from a third network node 133 to a second network node 132, whereas the previous method was for the case where a secondary connection did not exist for the UE beforehand, and it is to be set-up at the second network node 132. The information on secondary connection set-up failure may be obtained 258 as information received from the second network node 132, the information comprising the ID of the UE. Alternatively, the information may be obtained by the first network node 131 determining that there is a secondary connection set-up failure when no acknowledgement of performed secondary connection set-up has been received from the second network node 132 within a defined time period from the sending 254 of the request to the second network node 132. The third network node receives from the UE, the PCI of the cell that the UE enters. The third network node then has access to information on which PCI that belongs to which network node and uses that information to determine that the received PCI belongs to the ID of the second network node. When two cells have the same PCI, it may happen that the cell the UE entered was in fact not the cell of the second network node 132 but of another network node. Then the third network node receives the ID of the another network node and not that of the second network node. Then the second network node will not reach the UE when trying to set up a secondary connection and there will be a connection set-up failure. The advantages of the second network node sending an acknowledgement of a performed secondary connection set-up to the first network node, or the first network node obtaining information on a secondary connection set-up failure, depending on the result of the connection set-up, are the same for this method as for the previous method.

According to an embodiment of this method, the method further comprises, in response to the receiving 256 of the acknowledgement of the secondary connection set-up from the second network node 132, sending 260 information on the acknowledgement to the third network node 133, or, in response to the obtaining 258 of the information on secondary connection set-up failure with the UE 140, sending 261 information on secondary connection set-up failure to the third network node 133, the sent 260, 261 information comprising the ID of the UE 140.

By informing the third network node 133 of whether the secondary connection set-up failed or was successful, the third network node 133 would know whether the UE 140 should be treated further at the third network node or not. Further, the third network node 133 can collect statistics of such secondary connection change failures or successfulness which can be used when determining how to handle UEs that in the future would like to do a change of secondary connection or which can be used to determine any change of PCI for the third network node.

According to an embodiment of the method described in relation to FIG. 3 and/or the method described in relation to FIG. 2, the method further comprises monitoring 205, 255 any response from the second network node 132, to the request sent 204, 254 to the second network node, and receiving 206, 256 the acknowledgement of performed secondary connection or obtaining 208, 258 the information on secondary connection set-up failure as a result of the monitoring 205, 255. In other words, the first network node monitors 205, 255, i.e. checks whether it receives any response to the request of secondary connection set-up that it sent to the first network node. The monitoring may either result in that the first network node receives 206, 256 an acknowledgement or that it receives information from the second network node that the secondary connection set-up failed. Alternatively, if the monitoring results in that no information of secondary connection set-up result is received from the second network node within a certain time limit, the absent of any such information from the second network node may be interpreted as a failure of secondary connection set-up.

According to an embodiment of this method or the method described in relation to FIG. 2, the method further comprises selectively acting 210; 262 in response to whether the acknowledgement of performed secondary connection set-up was received or whether the information on secondary connection set-up failure was obtained. The action that the first network node 131 may take can be to request the UE to obtain a Cell Global Identity (CGI) of the cell, in case the information on secondary connection set-up failure was obtained and in case e.g. the reason for the non-successful connection set-up was a PCI conflict. Another action that the first network node 131 may take can be to collect information on received acknowledgements, and information on secondary connection set-up failures over time. Based on such collected statistics on received acknowledgements and obtained failure information, the first network node 131 can take actions on forthcoming received acknowledgements and/or obtained failure information, such as determining whether to perform a PCI reallocation.

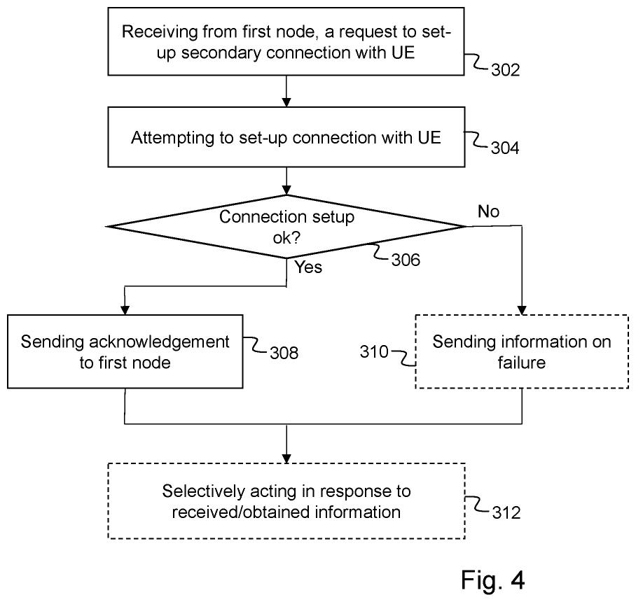

FIG. 4, in conjunction with FIG. 1, shows another method of the present invention. This method is from the side of the second network node 132 for the case when a secondary connection did not exist for the UE 140 beforehand and is to be set-up at the second network node. The method is performed by the second network node 132 of the wireless communication network 100, the second network node 132 being of a second radio access network technology. The wireless communication network 100 further comprises a first network node 131 of a first radio access technology. The first network node 131 has a direct signaling connection to the core network 120 whereas the second network node 132 is signaling-connected to the core network 120 via the first network node 131. The method comprises receiving 302 a request from the first network node 131 to set-up a secondary connection with a UE 140, the request including the ID of the UE, and after the receiving 302 of the request, attempting 304 to set up a secondary connection with the UE 140. The method further comprises determining 306 whether the attempt of secondary connection set-up was successful, and sending 308, to the first network node 131 and in response to the determining 306 that the secondary connection set-up was successful, an acknowledgement of a performed secondary connection set-up with the UE 140, the acknowledgement comprising an ID of the UE 140.

The attempt to set up a secondary connection with the UE may be to act according to known random-access procedure, e.g. to watch for received random access requests from the UE, and when a random access request is received, proceed according to known random-access procedures to set-up a connection. In case a contention-free access procedure is used, also called a Configured Grant (CG) procedure, the attempt to set up a secondary connection comprises the second network node allocating communication resources beforehand and informing the UE which communication resources it has been allocated for such a secondary connection. The second network node then watches any data communicated on such allocated transmission resources. Based on the sending 308 of an acknowledgement of performed secondary connection set-up to the first network node, the first network node can act on such received acknowledgement and also in the absence of such received acknowledgement as this would indicate a secondary connection set-up failure. The acting of the first network node could be to collect information on received acknowledgements, and absence of acknowledgements and determine statistics for the node and the network. Based on such statistics, the first network node can take actions on forthcoming received acknowledgements and/or obtained failure information, such as determining whether to perform a PCI reallocation. According to another embodiment, the second network node 132 can selectively act 312 in response to whether it was determined 306 that the attempt of secondary connection set-up was successful or not. The acting of the second network node 132 may be to collect information on determined successful secondary connections and secondary connection failures and determine statistics for the second network node 132 and the network 100.

According to an embodiment, the method described in FIG. 4 further comprises sending 310, to the first network node 131 and in response to determining 306 that the secondary connection set-up failed, information on a secondary connection set-up failure with the UE, the information on failure comprising the ID of the UE. When the second network node 132 actively sends information on secondary connection set-up failure to the first node, as for this embodiment, the first network node 131 would be more confident that there is a secondary connection failure than if such failure is determined at the first network node 131 based on absence of an acknowledgement of secondary connection set-up. The second network node 132 may determine that the secondary connection set-up failed by setting a timer from starting the secondary connection set-up procedure. When not receiving any response from the UE within the time set by the timer, a secondary connection set-up is determined.

The following embodiment of the method of FIG. 4 is for the case where a secondary connection already exists with a third network node 133 and needs to be changed for the UE 140 from the third network node 133 to the second network node 132. In this embodiment, the wireless communication network 100 consequently further comprises a third network node 133 of a second radio access network technology, the third network node 133 being signaling-connected to the core network 120 via the first network node 131. Then the received 302 request is for a UE 140 that has a primary connection to the first network node 131 and also a secondary connection to the third network node 133 and needs to change the secondary connection to the third network node, the request comprising the ID of the UE 140. The receiving 302 of the request, called second request, at the second network node 132 is then triggered by the first network node 131 upon receiving, from the third network node 133, a first request of a change of secondary connection initiated by the UE 140 entering a cell with a PCI matching a PCI of a cell controlled by the second network node 132. In other words, the first network node receives the first request from the third network node. The first request triggers the first network node to send the second request to the second network node, and the second request is then received 302 at the second network node.

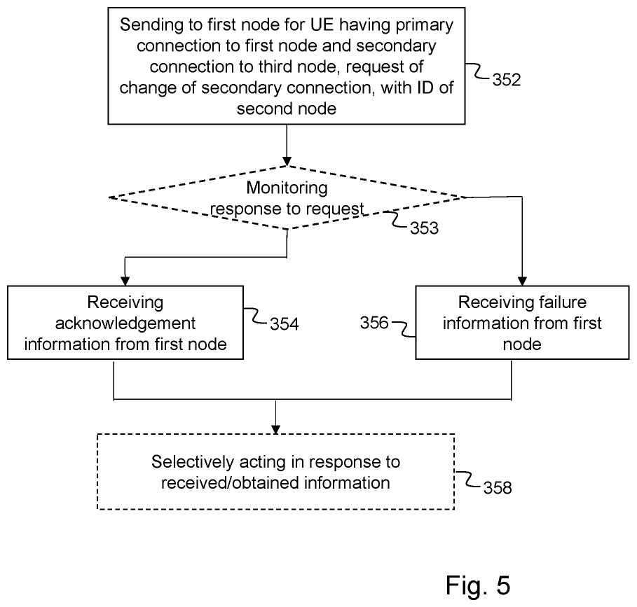

FIG. 5, in conjunction with FIG. 1 describes another method of the present invention. This method is performed by the third network node 133 of the wireless communication network 100, the third network node 133 being of a second radio access network technology. The wireless communication network 100 further comprises a first network node 131 of a first radio access technology and a second network node 132 of the second radio access technology. The first network node 131 has a direct signaling connection to a core network 120 whereas the second network node 132 and the third network node 133 are signaling-connected to the core network 120 via the first network node 131. The method comprises sending 352, to the first network node 131, for a UE 140 that has a primary connection to the first network node 131 and a secondary connection to the third network node 133, a request of a change of secondary connection, initiated by the UE 140 entering a cell with a PCI matching a PCI of a cell controlled by the second network node 132, the request comprising an ID of the second network node. The method further comprises receiving 354, from the first network node 131 information on an acknowledgement of a secondary connection set-up with the UE 140, or receiving 356 information on a secondary connection set-up failure, depending on whether the secondary connection set-up was successful or not, the information comprising an ID of the UE 140, the secondary connection set-up being initiated by the second network node 132 at request by the first network node 131 in response to the sent 352 request of change of secondary connection. According to an embodiment, the third network node 133 can selectively act 358 in response to the received information on acknowledgement or failure of secondary connection set-up. The acting of the third network node 133 may be to collect information on determined successful secondary connections and secondary connection failures and determine statistics for the third network node and the network 100.

This method is from the side of the third network node for the case where a secondary connection needs to be changed for a UE from the third network node to a second network node. By receiving of either information on acknowledgement of secondary connection set-up or secondary connection set-up failure from the first network node, the third node would know whether the UE should be treated further at the third node or not. Further, the third node can collect statistics of such secondary connection change failures or successfulness which can be used when determining how to handle UEs that in the future would like to do a change of secondary connection or which can be used to determine any change of PCI for the third node.

According to an embodiment, the method further comprises monitoring 353 any response from the first network node 131, to the request sent 352 to the first network node. Further, the method comprises receiving 354 the information on acknowledgement of performed secondary connection or receiving 356 the information on secondary connection set-up failure as a result of the monitoring 353.

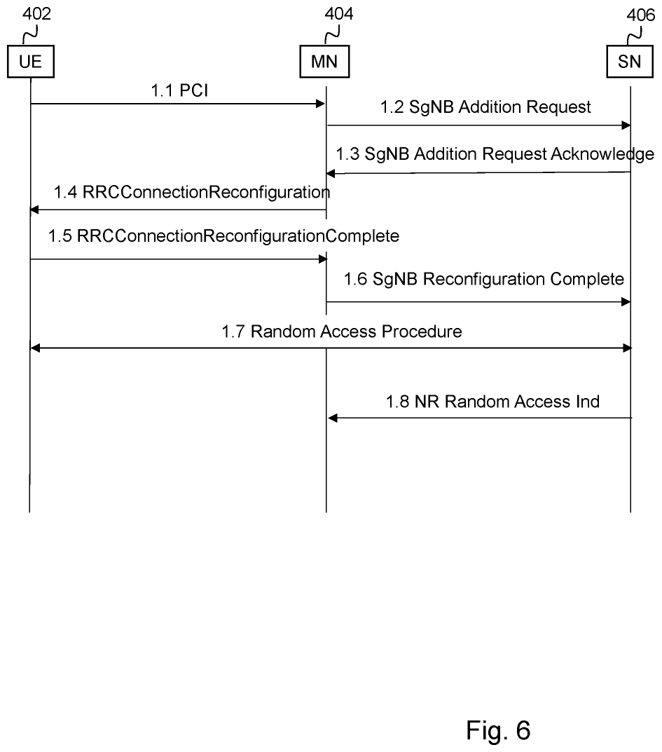

FIG. 6 is a signaling diagram showing an embodiment of a method, when setting up a secondary connection for a UE 402 to a secondary network node (SN) 406, the UE 402 having a primary connection to a first network node, which for this UE then functions as a Master network node (MN) 404. The SN 406 is signaling connected to the core network via the MN 404. In the example, the MN 404 is an eNB whereas the SN 406 is a gNB. However, other alternatives may apply, such as the MN being a gNB and the SN an eNB. Further, in this example a random access procedure is used for setting up the secondary connection, however other procedures may be used, such as a Configured Grant (CG) procedure.

The UE 402 together with e.g. measurement reports, reports 1.1 PCI of a cell to the MN 404 with which the UE has a primary connection. The MN 404 then for some reason decides to set up a secondary connection for the UE 402 with the SN 406. The MN 404 uses the PCI it received in the report from the UE 402 to determine to an ID of the SN 406. The MN 404 then sends a secondary gNB (SgNB) addition request message 1.2 to the SN 406, using the ID of the SN, requesting the SN to set-up a secondary connection with the UE, the request comprising an ID of the UE. The SN responds by acknowledging 1.3 the SgNB addition request. The MN 404 sends 1.4 a Radio Resource Control (RRC) Connection Reconfiguration message to the UE 402 to configure the UE for a secondary connection. The UE 402 responds 1.5 to the MN 404 by an RRC Connection Reconfiguration Complete when it has been completely configured. In response to the response 1.5, the MN 404 sends 1.6 a SgNB reconfiguration complete message to the SN 406. The SN 406 can then initiate 1.7 set-up of a secondary connection with the UE 402, using in this example a Random access procedure.

The SN 406 then determines whether the initiated secondary connection set-up was successful or not. When the secondary connection set-up was successful, the SN 406 sends 1.8 to the MN 404, a NR Random Access Indication (Ind), comprising the ID of the UE, informing the MN of started or successful secondary connection set-up. The SN 406 determines that the secondary connection set-up is successful when the random access procedure is successful. Further, the MN 404 obtains information on secondary connection set-up failure. According to one embodiment, the MN 404 obtains information on secondary connection set-up failure by receiving 1.8 a NR Random Access Ind from the SN 406 when the SN 406 has determined that the secondary connection set-up failed. The NR Random Access Ind in case of failure would then indicate a failure and comprise the ID of the UE. According to another embodiment, the MN 404 obtains information on secondary connection set-up failure by itself determining that it has not received any NR Random Access Ind informing the MN of successful secondary connection set-up within a certain time period from the sending of the SgNB Addition Request or the sending of the SgNB Reconfiguration Complete. The SN 406 determines that the secondary connection set-up has failed for example when the SN has not received any random access request from the UE 402 within a defined time. When the MN 404 receives a NR Random Access Ind from the SN 406, the MN 404 may take actions such as building up statistics on success rate for each cell. Such statistics may be used to for example eventually change PCI on a cell in case there are lots of failures.

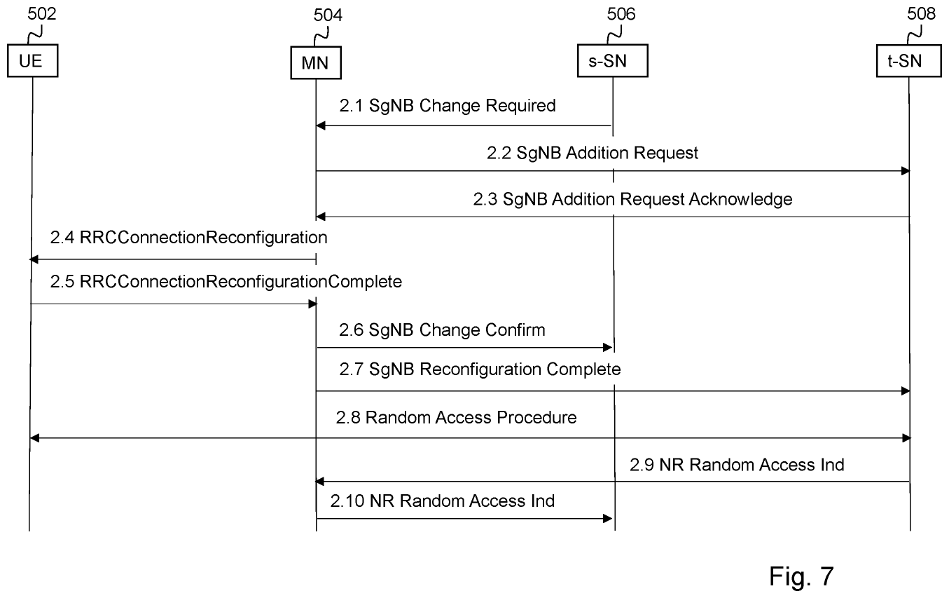

FIG. 7 is a signaling diagram showing an embodiment of a method, when moving a secondary connection for a UE 502 from a source secondary node (s-SN) 506 to a target secondary node (t-SN) 508. The UE 502 has a primary connection to a first network node, which for this UE then functions as a Master network node (MN) 504. The UE 502 further has a secondary connection to the s-SN 506. The s-SN 506 and the t-SN 508 are signaling connected to the core network via the MN 504. In the example, the MN 504 is an eNB whereas the s-SN 506 and the t-SN are gNBs. However, other alternatives may apply, such as the MN 504 being a gNB and the s-SN 506 and the t-SN 508 eNBs. Further, in this example a random access procedure is used for setting up the secondary connection, however other procedures may be used, such as a Configured Grant (CG) procedure.

The UE 502 moves from an NR cell of the s-SN 506 and comes into another NR cell of another gNB. The s-SN 506 then determines that the UE 502 should change secondary node based on the signal strength measurements that it received from the UE 502 indicating that the signals of the another gNB is strong enough for a change. The s-SN 506 initiates the change of secondary node by sending 2.1 a message called SgNB Change Required to the MN 502 including an ID of the target gNB. The MN 504 sends 2.2 a message called SgNB Addition Request to the t-SN 508 using the ID of the target gNB it received. The t-SN responds 2.3 to the SgNB Addition Request with a SgNB Addition Request Acknowledgement that it sends to the MN 504. The MN 404 then sends 2.4 a RRC Connection Reconfiguration message to the UE 502 to configure the UE for a change of secondary connection. The UE 502 responds 2.5 to the MN 504 by an RRC Connection Reconfiguration Complete when it has been completely configured. In response to the response 2.5, the MN 504 sends 2.6 a SgNB Change Confirm message to the s-SN 506 to confirm that change of secondary node is to be performed. The MN 504 further sends 2.7 a SgNB reconfiguration complete message to the SN 506. The SN 506 can then initiate 2.8 set-up of a secondary connection with the UE 502, using in this example a Random access procedure.

Before sending the SgNB Change required message 2.1, the s-SN 506 looked up the ID of the target gNB from a PCI that accompanied the signal strength measurements that it received from the UE. If the s-SN 506 is involved in a PCI confusion, there is a risk that the wrong target gNB ID was included in the SgNB change required message 2.1, as there are two cells having same PCI so there will be two different gNBs with the same PCI. In case the wrong target gNB ID was included in the message 2.1, the MN 504 will then send the SgNB Addition Request message 2.2 to the wrong target gNB. As a result, the set-up of secondary connection at the t-SN 508 will fail. In order to be able to take actions on such situations and any other situation where a secondary connection set-up would fail, the t-SN 508 determines whether the initiated secondary connection set-up was successful or not, and when the secondary connection set-up was successful, sends 2.9 to the MN 504, a NR Random Access Ind, comprising the ID of the UE, informing the MN 504 of successful secondary connection set-up. According to an embodiment, the t-SN 508 may also send, to the MN 504, an NR Random Access Ind when it has determined that the secondary connection set-up failed. The NR Random Access Ind in case of failure would then inform the MN 504 of the failure, as well as the ID of the UE. The t-SN 508 determines that the secondary connection set-up is successful when the random access procedure is successful. The t-SN 508 determines that the secondary connection set-up has failed for example when the t-SN 508 has not received any random access request from the UE 502 within a defined time. When the MN 504 receives a NR Random Access Ind from the t-SN 508, the MN 504 may take actions such as building up statistics on success rate for each cell. Such statistics may be used to for example eventually change PCI on a cell in case there are lots of failures. According to an embodiment, the MN 504 may also send 2.10 a Random Access Ind to the s-SN 506 so that the s-SN would know whether the change of secondary connection to the t-SN was successful or not.

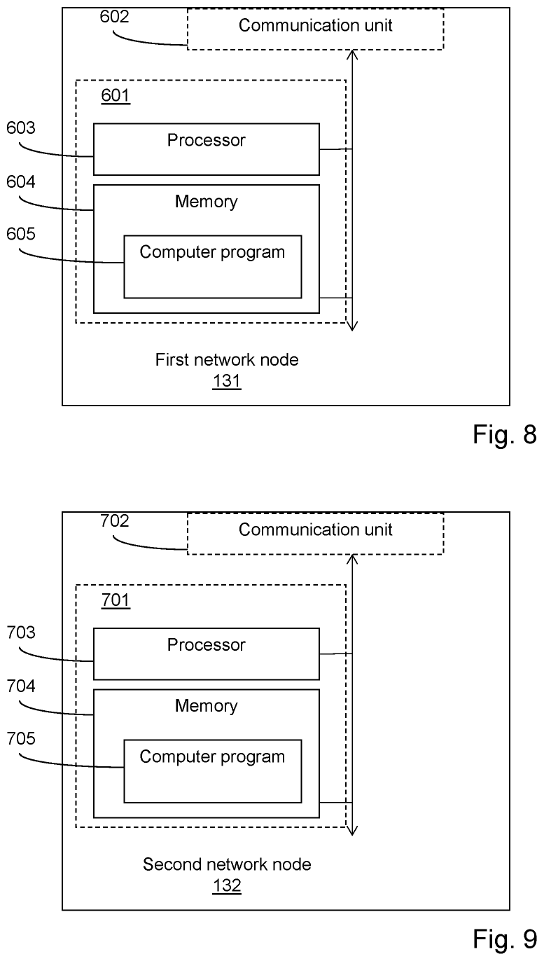

FIG. 8, in conjunction with FIG. 1, describes a first network node 131 configured to operate in a wireless communication network 100. The first network node 131 is of a first radio access network technology. The wireless communication network 100 further comprising a second network node 132 of a second radio access technology. The first network node 131 is configured to have a direct signaling connection to a core network 120 whereas the second network node 132 is configured to be signaling-connected to the core network 120 via the first network node 131. The first network node 131 comprises a processing circuitry 603 and a memory 604. Said memory contains instructions executable by said processing circuitry, whereby the first network node 131 is operative for receiving, from a UE 140 that has a primary connection to the first network node 131, a PCI that matches a PCI of a cell 152 controlled by the second network node 132, and in response to the reception of the PCI, sending a request to the second network node 132 initiating the second network node to set-up a secondary connection with the UE 140. The first network node 131 is further operative for receiving from the second network node 132, an acknowledgement of a performed secondary connection set-up with the UE 140, the acknowledgement comprising an ID of the UE 140, or, obtaining information on a secondary connection set-up failure with the UE 140.

FIG. 8, in conjunction with FIG. 1, also describes a first network node 131 configured to operate in a wireless communication network 100, where the first network node 131 is of a first radio access network technology. However, here the wireless communication network 100 further comprises a second network node 132 as well as a third network node 133 both of a second radio access technology. The first network node 131 is configured to have a direct signaling connection to the core network 120 whereas the second network node 132 and the third network node 133 are configured to be signaling-connected to the core network 120 via the first network node 131. The first network node 131 comprises a processing circuitry 603 and a memory 604. Said memory contains instructions executable by said processing circuitry, whereby the first network node 131 is operative for receiving, from the third network node 133, for a UE 140 that has a primary connection to the first network node 131 and a secondary connection to the third network node 133, a request of a change of secondary connection, initiated by the UE 140 entering a cell with a PCI matching a PCI of a cell controlled by the second network node 132, the request comprising an ID of the second network node, and, in response to the receiving, sending a request to the second network node 132 initiating the second network node 132 to set-up a secondary connection with the UE 140, the request comprising the ID of the UE 140. Further, the first network node 131 is operative for receiving, from the second network node 132, an acknowledgement of a performed secondary connection set-up with the UE 140, the acknowledgement comprising an ID of the UE 140, or, obtaining information on a secondary connection set-up failure with the UE.

According to an embodiment, the first network node 131 is further operative for, in response to the receiving of the acknowledgement of the secondary connection set-up from the second network node 132, sending information on the acknowledgement to the third network node 133, or, in response to the obtaining of the information on secondary connection set-up failure with the UE 140, sending information on secondary connection set-up failure to the third network node 133, the sent information comprising the ID of the UE.

According to another embodiment, the first network node 131 is further operative for monitoring any response from the second network node 132 to the request sent to the second network node and receiving the acknowledgement of performed secondary connection or obtaining the information on secondary connection set-up failure as a result of the monitoring.

According to another embodiment, the first network node 131 is further operative for selectively acting in response to whether the acknowledgement of performed secondary connection set-up was received or whether the information on secondary connection set-up failure was obtained.

FIG. 9, in conjunction with FIG. 1, discloses a second network node 132 configured to operate in a wireless communication network 100. The second network node 132 is of a second radio access network technology. The wireless communication network 100 further comprising a first network node 131 of a first radio access technology. The first network node 131 is configured to have a direct signaling connection to a core network 120 whereas the second network node 132 is configured to be signaling-connected to the core network 120 via the first network node 131. The second network node 132 comprises a processing circuitry 703 and a memory 704. Said memory contains instructions executable by said processing circuitry, whereby the second network node 132 is operative for receiving a request from the first network node 131 to set-up a secondary connection with a UE 140, the request including the ID of the UE, and, after the receiving of the request, attempting to set up a secondary connection with the UE. The second network node 132 is further operative for determining whether the attempt of secondary connection set-up was successful, and sending, to the first network node 131 and in response to the determining that the secondary connection set-up was successful, an acknowledgement of a performed secondary connection set-up with the UE 140, the acknowledgement comprising an ID of the UE 140.

According to an embodiment, the second network node 132 is further operative for sending, to the first network node 131 and in response to determining that the secondary connection set-up failed, information on a secondary connection set-up failure with the UE, the information on failure comprising the ID of the UE.

According to another embodiment, the wireless communication network 100 further comprises a third network node 133 of the second radio access network technology, the third network node 133 being signaling-connected to the core network 120 via the first network node 131. Further, the received request to set-up a secondary connection is for a UE 140 that has a primary connection to the first network node 131 and a secondary connection to the third network node 133, the request comprising the ID of the UE 140. Further, the receiving of the request is triggered by the first network node 131 receiving, from the third network node 133, a request of a change of secondary connection initiated by the UE 140 entering a cell with a PCI matching a PCI of a cell controlled by the second network node 132.

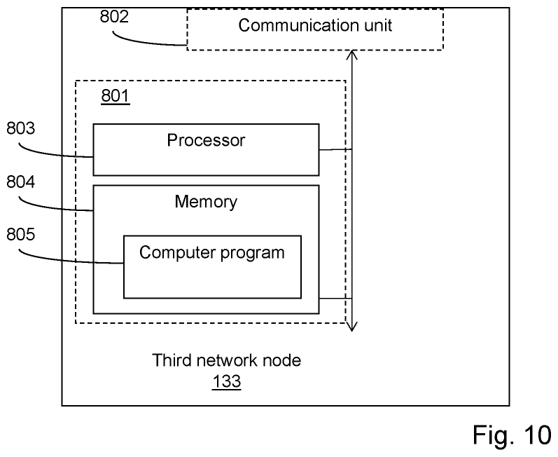

FIG. 10, in conjunction with FIG. 1, discloses a third network node 133 configured to operate in a wireless communication network 100, the third network node 133 being of a second radio access network technology. The wireless communication network 100 further comprising a first network node 131 of a first radio access technology and a second network node 132 of the second radio access technology. The first network node 131 is configured to have a direct signaling connection to a core network 120 whereas the second network node 132 and the third network node 133 are configured to be signaling-connected to the core network 120 via the first network node 131. The third network node 133 comprises a processing circuitry 803 and a memory 804. Said memory contains instructions executable by said processing circuitry, whereby the third network node 133 is operative for sending, to the first network node 131, for a UE 140 that has a primary connection to the first network node 131 and a secondary connection to the third network node 133, a request of a change of secondary connection, initiated by the UE 140 entering a cell with a PCI matching a PCI of a cell controlled by the second network node 132, the request comprising an ID of the second network node. The third network node 133 is further operative for receiving, from the first network node 131 information on an acknowledgement of a secondary connection set-up with the UE 140, or receiving information on a secondary connection set-up failure, depending on whether the secondary connection set-up was successful or not, the information comprising an ID of the UE 140, the secondary connection set-up being initiated by the second network node 132 at request by the first network node 131 in response to the sent request of change of secondary connection.

According to an embodiment, the third network node 133 is further operative for monitoring any response from the first network node 131 to the request sent to the first network node and receiving the information on acknowledgement of performed secondary connection or receiving the information on secondary connection set-up failure as a result of the monitoring

According to other embodiments, applicable to the first network node 131 of FIG. 8 as well as to the second network node 132 of FIG. 9 and the third network node 133 of FIG. 10, the first network node 131, second network node 132 and third network node 133 may respectively further comprise a communication unit 602; 702; 802 which may be considered to comprise conventional means for wireless communication with the wireless device 140, such as a transceiver for wireless transmission and reception of signals in the communication network. The respective communication unit 602; 702; 802 may also comprise conventional means for communication with other network nodes of the wireless communication network 100, such as the first, second and the third network nodes 131, 132, 133, respectively. The instructions executable by said respective processing circuitry 603; 703; 803 may be arranged as a respective computer program 605; 705; 805 stored e.g. in the respective memory 604; 704; 804. The respective processing circuitry 603; 703; 803 and memory 604; 704; 804 may be arranged in a respective sub-arrangement 601; 701; 801. The respective sub-arrangement 601; 701; 801 may be a micro-processor and adequate software and storage therefore, a Programmable Logic Device, PLD, or other electronic component(s)/processing circuit(s) configured to perform the methods mentioned above. The respective processing circuitry 603; 703; 803 may comprise one or more programmable processor, application-specific integrated circuits, field programmable gate arrays or combinations of these adapted to execute instructions.

The respective computer program 605; 705; 805 may be arranged such that when its instructions are run in the processing circuitry, they cause respective ones of the first network node 130; the second network node 132 and the third network node 133 to perform the steps described in any of the described embodiments of the first, second and third network nodes 131, 132, 133 and their methods. The respective computer program 605; 705; 805 may be carried by a computer program product connectable to the respective processing circuitry 603; 703; 803. The respective computer program product may be the respective memory 604; 704; 804, or at least arranged in the respective memory. The respective memory 604; 704; 804 may be realized as for example a RAM (Random-access memory), ROM (Read-Only Memory) or an EEPROM (Electrical Erasable Programmable ROM). In some embodiments, a respective carrier may contain the respective computer program 605; 705; 805. The respective carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the respective program could be downloaded into the respective memory 604; 704; 804. Alternatively, the respective computer program may be stored on a server or any other entity to which the respective one of the first, second and third network nodes 131, 132, 133 have access via their respective communication unit 602; 702; 802. The respective computer program 605; 705; 805 may then be downloaded from the server into the respective memory 604; 704; 804.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a first network node of a wireless communication network, the first network node being of a first radio access network technology, the wireless communication network further comprising a second network node of a second radio access technology, the first network node having a direct signaling connection to a core network whereas the second network node is signaling-connected to the core network via the first network node, the method comprising:
receiving, from a User Equipment, UE, that has a primary connection to the first network node, a Physical Cell Identity, PCI, that matches a PCI of a cell controlled by the second network node;
in response to the reception of the PCI, sending a request to the second network node initiating the second network node to set-up a secondary connection with the UE, and
receiving, from the second network node, an acknowledgement of a performed secondary connection set-up with the UE, the acknowledgement comprising an ID of the UE, or, obtaining information on a secondary connection set-up failure with the UE.

2. A method performed by a first network node of a wireless communication network, the first network node being of a first radio access network technology, the wireless communication network further comprising a second network node and a third network node, both of a second radio access technology, the first network node having a direct signaling connection to a core network whereas the second and third network nodes are signaling-connected to the core network via the first network node, the method comprising:
receiving, from the third network node, for a UE that has a primary connection to the first network node and a secondary connection to the third network node, a request of a change of secondary connection, initiated by the UE entering a cell with a PCI matching a PCI of a cell controlled by the second network node, the request comprising an ID of the second network node;
in response to the receiving, sending a request to the second network node initiating the second network node to set-up a secondary connection with the UE, the request comprising the ID of the UE, and
receiving, from the second network node, an acknowledgement of a performed secondary connection set-up with the UE, the acknowledgement comprising an ID of the UE, or, obtaining information on a secondary connection set-up failure with the UE.

3. Method according to claim 2, further comprising, in response to the receiving of the acknowledgement of the secondary connection set-up from the second network node, sending information on the acknowledgement to the third network node, or, in response to the obtaining of the information on secondary connection set-up failure with the UE, sending information on secondary connection set-up failure to the third network node, the sent information comprising the ID of the UE.

4. Method according to claim 1, further comprising:
monitoring any response from the second network node to the request sent to the second network node, and receiving the acknowledgement of performed secondary connection or obtaining the information on secondary connection set-up failure as a result of the monitoring.

5. Method according to claim 1, further comprising:
selectively acting in response to whether the acknowledgement of performed secondary connection set-up was received or whether the information on secondary connection set-up failure was obtained.

6. A method performed by a second network node of a wireless communication network, the second network node being of a second radio access network technology, the wireless communication network further comprising a first network node of a first radio access technology, the first network node having a direct signaling connection to a core network whereas the second network node is signaling-connected to the core network via the first network node, the method comprising:
receiving a request from the first network node to set-up a secondary connection with a UE, the request including the ID of the UE,
after the receiving of the request, attempting to set up a secondary connection with the UE;
determining whether the attempt of secondary connection set-up was successful, and
sending, to the first network node and in response to the determining that the secondary connection set-up was successful, an acknowledgement of a performed secondary connection set-up with the UE, the acknowledgement comprising an ID of the UE.

7. Method according to claim 6, further comprising:
sending, to the first network node and in response to determining that the secondary connection set-up failed, information on a secondary connection set-up failure with the UE, the information on failure comprising the ID of the UE.

8. Method according to claim 6, where the wireless communication network further comprises a third network node of the second radio access network technology, the third network node being signaling-connected to the core network via the first network node, and wherein the received request is for a UE that has a primary connection to the first network node and a secondary connection to the third network node, the request comprising the ID of the UE, the receiving of the request being triggered by the first network node receiving, from the third network node, a request of a change of secondary connection initiated by the UE entering a cell with a PCI matching a PCI of a cell controlled by the second network node.

9. A method performed by a third network node of a wireless communication network, the third network node being of a second radio access network technology, the wireless communication network further comprising a first network node of a first radio access technology and a second network node of the second radio access technology, the first network node having a direct signaling connection to a core network whereas the second network node and the third network node are signaling-connected to the core network via the first network node, the method comprising:
sending, to the first network node, for a UE that has a primary connection to the first network node and a secondary connection to the third network node, a request of a change of secondary connection, initiated by the UE entering a cell with a PCI matching a PCI of a cell controlled by the second network node, the request comprising an ID of the second network node, and
receiving, from the first network node information on an acknowledgement of a secondary connection set-up with the UE, or receiving information on a secondary connection set-up failure, depending on whether the secondary connection set-up was successful or not, the information comprising an ID of the UE, the secondary connection set-up being initiated by the second network node at request by the first network node in response to the sent request of change of secondary connection.

10. Method according to claim 9, further comprising:
monitoring any response from the first network node to the request sent to the first network node, and receiving the information on acknowledgement of performed secondary connection or receiving the information on secondary connection set-up failure as a result of the monitoring.

11-28. (canceled)
